(19) United States
(12) Patent Application Publication
(10) Pub. No.: US 2016/0198874 A1
(43) Pub. Date: Jul. 14, 2016

(54) DETACHABLE STORAGE CONTAINER FOR A DRINKS CONTAINER

(71) Applicant: Eric Pisarevsky, Montreal (CA)

(72) Inventor: Eric Pisarevsky, Montreal (CA)

(21) Appl. No.: 14/991,162

(22) Filed: Jan. 8, 2016

Related U.S. Application Data
(60) Provisional application No. 62/102,042, filed on Jan. 11, 2015.

(51) Int. Cl. A47G 19/22; B65D 21/02; A61J 7/04

(52) U.S. Cl. CPC A47G 19/2205; A61J 7/04; B65D 21/0237

(57) ABSTRACT

A detachable storage container for a drinks container comprising of: a storage container comprising of a plurality of storage compartments; a plurality of lids, each lid attached to a compartment, each lid openable and closable, and a distinguishing mark on each lid; and a slide track on each side of the storage container to attach and detach to and from a drinks container; a drinks container comprising of a drinks container with a deep wide groove and slide tracks to attach and detach the detachable storage compartments; a drinks container with legs to support the drinks container in a lying position; and a removable cap with a partially flat surface to be used as a drinking cup.

### CROSS REFERENCE TO PREVIOUS APPLICATION

This application claims the benefit of the U.S. Provisional Application No. 62/102,042, filed Jan. 11, 2015, the disclosure of which incorporated herein by reference.

### STATEMENT REGARDING FEDERALLY SPONSORED RESEARCH OR DEVELOPMENT

Not applicable.

### BACKGROUND

Many people use small and portable storage containers as pill dispensers to assist in the management of their medication and vitamin needs. These storage containers may be divided into daily use compartments. Many people ingest their pills with the assistance of a liquid.

Thus there is a need to provide a means for a person to attach and detach the portable storage container to a drinks container to allow the person to have the medication or vitamins and accompanying liquid readily available for daily ingestion in any location at any time.

### SUMMARY

The disclosed invention relates to a detachable storage container for a drinks container comprising of: a storage container comprising of: a plurality of storage compartments; a plurality of lids, each lid attached to a compartment, each lid openable and closable, and a distinguishing mark on each lid; a drinks container comprising of: a drinks container with a deep wide groove and slide tracks on each side of the groove to attach and detach the detachable storage container, a drinks container with stabilizing supports on the rear wall of the drinks container to support the drinks container in a lying position, and a removable cap with a partially flat surface which may be used as a drinking cup.

### BRIEF DESCRIPTION OF DRAWINGS

The present disclosure will be better understood by those skilled in the pertinent art by referencing the accompanying drawings, where like elements are numbered alike in the several figures, in which:

FIG. 1 is a front view of the disclosed detachable storage container attached to the drinks container with one of the storage compartment lids of the detachable storage container in an open position;

FIG. 2 is an upright perspective view of the detachable storage container detaching from the drinks container;

FIG. 3 is a perspective view of the detachable storage container with one of the storage compartment lids in an open position exposing the storage compartment;

FIG. 4 is a side rear view of the drinks container with the stabilizing supports clearly visible;

FIG. 5 is a perspective view of the components that may comprise the present invention; the detachable storage container, the drinks container and the cap of the drinks container removed which may be useful as a cup for a drink;

### DETAILED DESCRIPTION

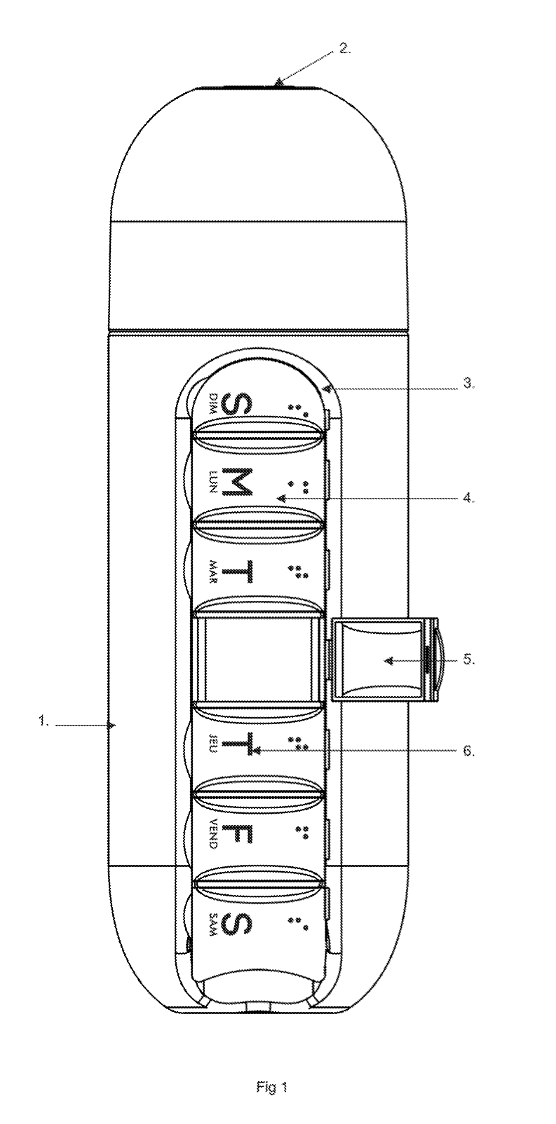

FIG. 1 is the front view of the disclosed detachable storage container and the drinks container 1. The drinks container may comprise of a cap with a flat surface that can be used a cup 2. The detachable storage container may be attached to and detached from the wall of the drinks container 3. The detachable storage container 3 may comprise of a plurality of compartments 4, each of which has a lid which may be opened to allow access to the storage compartment and closed to prevent access to the storage compartments. The lids may be provided with indicia 6, for example indicating days of the week, in order to simplify differentiation therebetween;

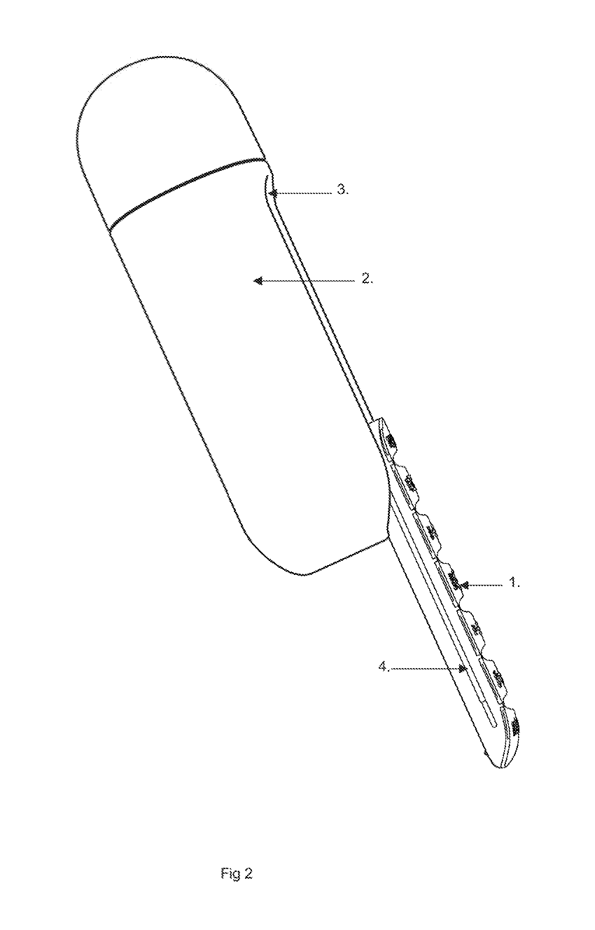

FIG. 2 is an upright perspective view of the storage container 1 in which the storage container is shown being detached from the drinks container 2 using a sliding motion along the deep wide groove and slide track of the drinks container 3 and the slide tracks of the storage container 4. The rear stabilizing supports 5 are shown;

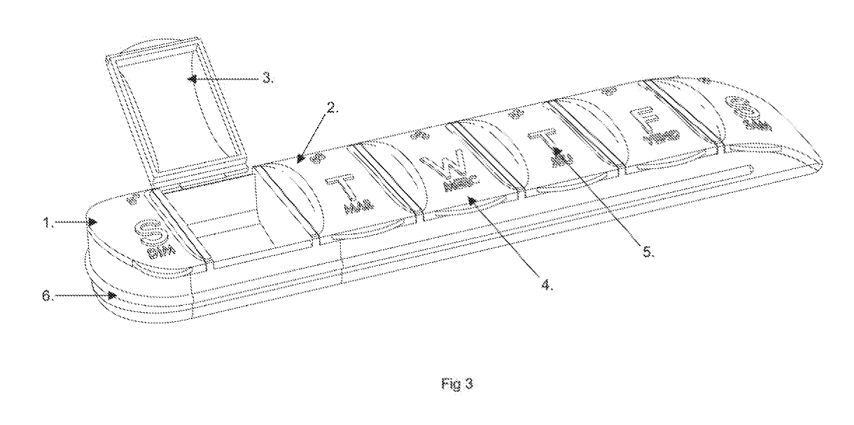

FIG. 3 is a perspective view of the detachable storage container 1. The storage container may comprise of a plurality of compartments 2, with each compartment having a lid that opens 3 to allow access to the storage space in the compartment and closes 4 to prevent access to the storage space in the compartment. The lids may be provided with indicia 5, for example indicating the days of the week, in order to differentiate therebetween. The lid may be of any suitable material or structure. The compartments may be sized so as to each store a small number of pills and, as such, the detachable storage container may be useful as a pillbox. The storage container may have a slide track on each side 6 to allow for sliding in and out of the storage container to attach to and detach from the drinks container;

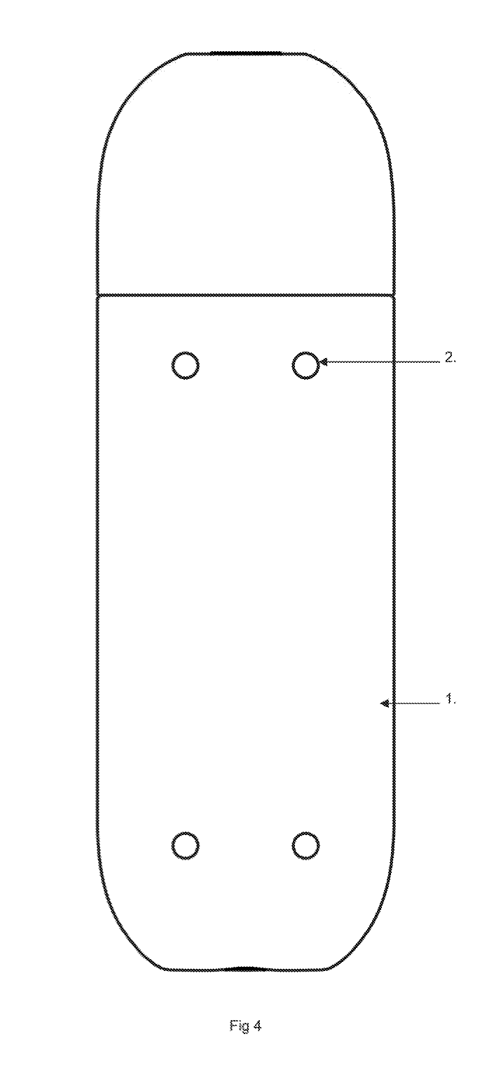

FIG. 4 is a side rear view of the storage container 1 with the stabilizing supports 2 dearly visible. The supporting legs may serve to support the container in a lying down position when the storage container is being attached to and detached from the drinks container and when the compartments are being accessed; and

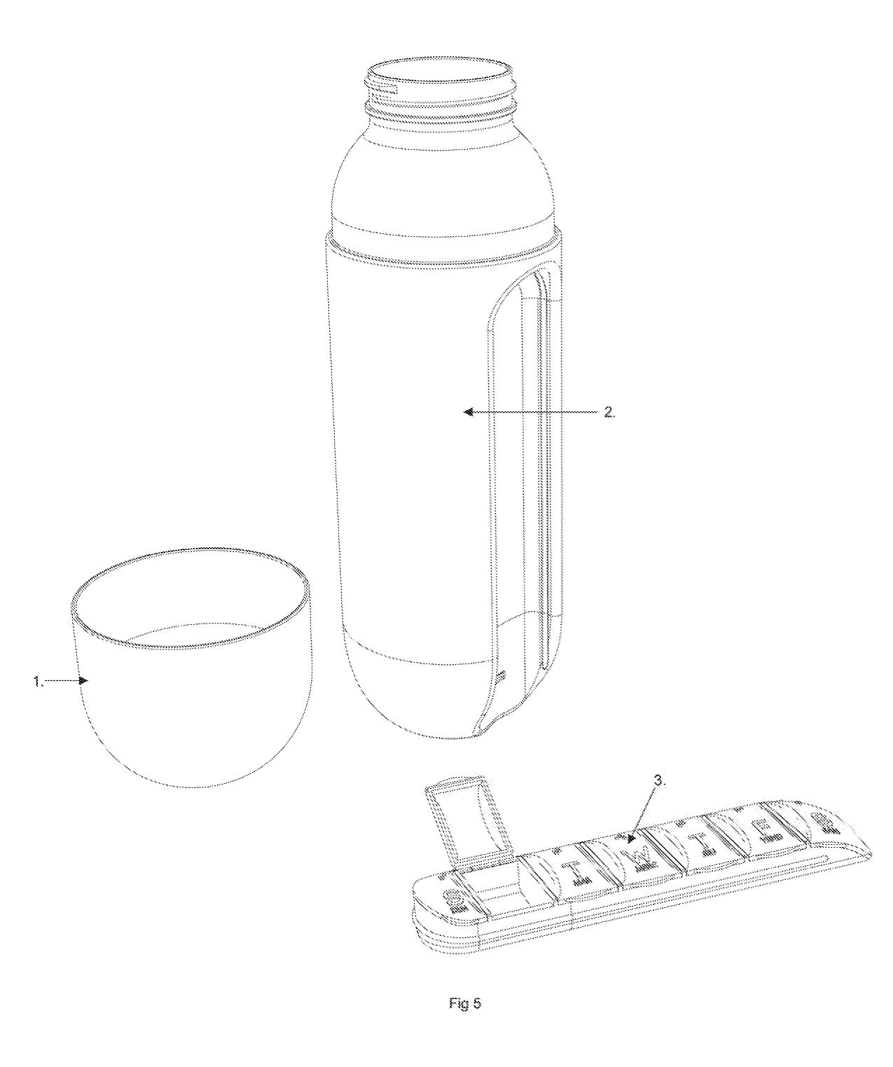

FIG. 5 is a perspective view of the components that may comprise the present invention. The cap 1 of the drinks container 2 is shown in an upright position which may be used as a cup to drink a beverage. the drinks container 2 and the detachable storage container with one lid open to access the storage compartment.

While the disclosure has been described with reference to the present invention, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore it is intended that the disclosure not be limited to the particular embodiments disclosed as the best mode contemplated for carrying out this disclosure, but that the disclosure will include all embodiments falling within the scope of the appended claims.

What is claimed is:

1. A detachable storage container with storage compartments for a drinks container comprising:
a detachable storage container; the storage container comprising:
a plurality of storage compartments,
a plurality of lids, each individual lid openable and closable,
indicia on each lid,
and
slide tracks on each side that may be useful to attach and detach the storage container;
a drinks container comprising:
a drinks container,
a deep wide groove on one wall with slide tracks on each side of the groove which may be useful to attach and detach the storage container,
supporting legs attached to the drinks container which may be useful to support the drinks container when sliding the storage container, and
a cap with a flat base that may be useful as a cup.
